(19) United States
(12) Patent Application Publication
(10) Pub. No.: US 2009/0210440 A1
(43) Pub. Date: Aug. 20, 2009

(54) METHOD AUTHORING METHOD

(75) Inventors: J. Todd Fredrickson, Rockledge, FL (US); Margaret M. Hedstrom, Raleigh, NC (US); Kelli A. Houston, Orlando, FL (US); Cecile M. Peraire, Mountain View, CA (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/032,329

(22) Filed: Feb. 15, 2008

(51) Int. Cl. G06F 7/06; G06F 17/30

(52) U.S. Cl. 707/102; 707/E17.005; 707/E17.032

(57) ABSTRACT

Embodiments of the present invention address deficiencies of the art in respect to method authoring and provide a method and computer program product for method authoring according to an inception phase, an elaboration phase, a construction phase and a transition phase. In an embodiment of the invention, a method authoring method can be provided to include generating a method sketch for a method from a vision and project plan for the method. The method sketch can include a walkthrough of a lifecycle for the method. Thereafter, a method definition can be defined from the method sketch and the method definition can be transformed into a Web site for the method. Finally, the Web site can be published for review by reviewers of the method, and the method definition can be iteratively refined based upon the review of the Web site.

### BACKGROUND OF THE INVENTION

1. Field of the Invention

The present invention relates to the field of conceptual frameworks and tool support for the management of methods and processes, and more particularly to the authoring of methods and processes.

2. Description of the Related Art

A method architecture describes a schema for organizing large amounts of descriptions for development methods and processes, such as software engineering, mechanical engineering, business transformation, sales cycles and the like. A development method provides step-by-step explanations for a particular way of achieving a specific development goal under general circumstances such as transforming a requirements document into an analysis model, defining an architectural mechanism based on functional and non-functional requirements, creating a project plan for a development iteration, defining a quality assurance plan for functional requirements, or redesigning a business organization based on a new strategic direction.

A development process takes several of these methods and combines method steps into semi-ordered sequences creating a structure that is specific to temporal development circumstances such as how work is to be organized over time. The structure also can be specific to one type of development project, for instance the characteristics of the development project including development software for an online system versus software and hardware for an embedded system. A process is defined based on a lifecycle, which specifies how method elements such as tasks are being applied and work products are being produced over time by particular roles within the process.

Presently, there are several frameworks available in industry for the documentation of methods and the specification of processes. Commercial method and process management products include the Rational Unified Process Workbench manufactured by IBM Corporation of Armonk, N.Y., United States. International standards for schemas for method and process management systems also exist. The most widely know standard of this field is the Software Process Engineering Meta-Model (SPEM) version 1.1 released by the Object Management Group (OMG).

For a growing number, writing methods and processes have become important because of the need for regulatory and standards compliance, process certification, as well as the more traditional need to increase efficiency, repeatability, and predictability. Still, the authoring of methods and processes of any significant size can be complex, involving multiple teams that may be distributed across many geographies and time zones. As such, undertaking methods authorship requires a rigorous and well-defined process in order to ensure that the teams can work together and that transitions are well understood and seamless.

Notwithstanding, at present there is a lack of processes and guidance currently available to support method development, teams often rely on best practices from software development. However, developing a method is not quite the same as developing a software application. One notable difference includes the focus in method development on producing textual and graphical content—all connected by a network of links and usage threads and supported by a presentation scheme. Software development, in contrast, focuses on producing code. Because of this fundamental difference, applying software development methods to method development is often not applicable, and therefore there is a pressing need for processes and guidance adapted to the specificity of method development.

### BRIEF SUMMARY OF THE INVENTION

Embodiments of the present invention address deficiencies of the art in respect to method authoring and provide a novel and non-obvious method, system and computer program product for method authoring. In an embodiment of the invention, a method authoring method can be provided to include generating a method sketch for a method from a vision and project plan for the method. The method sketch can include a walkthrough of a lifecycle for the method. Thereafter, a method definition can be defined from the method sketch and the method definition can be transformed into a Web site for the method. Finally, the Web site can be published for review by reviewers of the method, and the method definition can be iteratively refined based upon the review of the Web site.

In one aspect of the embodiment, generating the method sketch can include identifying a method development strategy, reviewing existing assets to identify reusable ones of the existing assets in defining the method, further identifying candidate method elements deemed relevant to the method, yet further identifying candidate relationships between the further identified candidate method elements, and describing selected ones of the candidate method elements. In yet another aspect of the embodiment, constructing a method definition from the method sketch can include defining a structure for method elements of the method in terms of key plug-ins and packages and corresponding dependencies, further defining the method elements and relationships between the method elements, yet further defining navigation views for a Web site reflecting the structure of the method elements, the defined method elements and the relationships, and, even yet further defining method configurations by selecting a set of components and navigation views to be published in the Web site.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A through 1D, taken together, are a pictorial illustration of a process for method authoring;

FIG. 2 is a schematic illustration of a method authoring data processing system; and,

FIG. 3 is a flow chart illustrating a process for method authoring.

### DETAILED DESCRIPTION OF THE INVENTION

Embodiments of the present invention provide a method, system and computer program product for process for method authoring. In accordance with an embodiment of the present invention, a method authoring method can be provided. The method can include by way of example, four distinct phases of development: an inception phase, an elaboration phase, a construction phase and a transition phase. In the inception phase, a method development strategy can be identified, existing assets can be reviewed to locate reuse opportunities, candidate method elements can be determined that are relevant to the method, candidate relationships between the candidate method elements can be identified and a method sketch acting as an early description for key candidate method elements can be drafted.

In the elaboration phase, method plug-ins relevant to the method and corresponding dependencies can be defined, method packages for the plug-ins also can be defined and the method elements can be logically categorized into a method structure. Navigation views also can be composed and method configurations can be determined by selecting a set of the method plug-ins and method packages to be published. Thereafter, feedback can be received from stakeholders in respect to the method structure. In the construction phase, the method design can be completely defined to include all structural elements and the relationships there between. The method element descriptions can be completed and reviewed and a Web site can be provided to illustrate the method. Also, an iteration plan can be completed and reviewed and the risks can be updated and reviewed. Finally, in the transition phase, feedback received from reviewers can be accounted for and applied to the method iteratively according to the iteration plan in order to produce and publish a final Web site as a project deliverable.

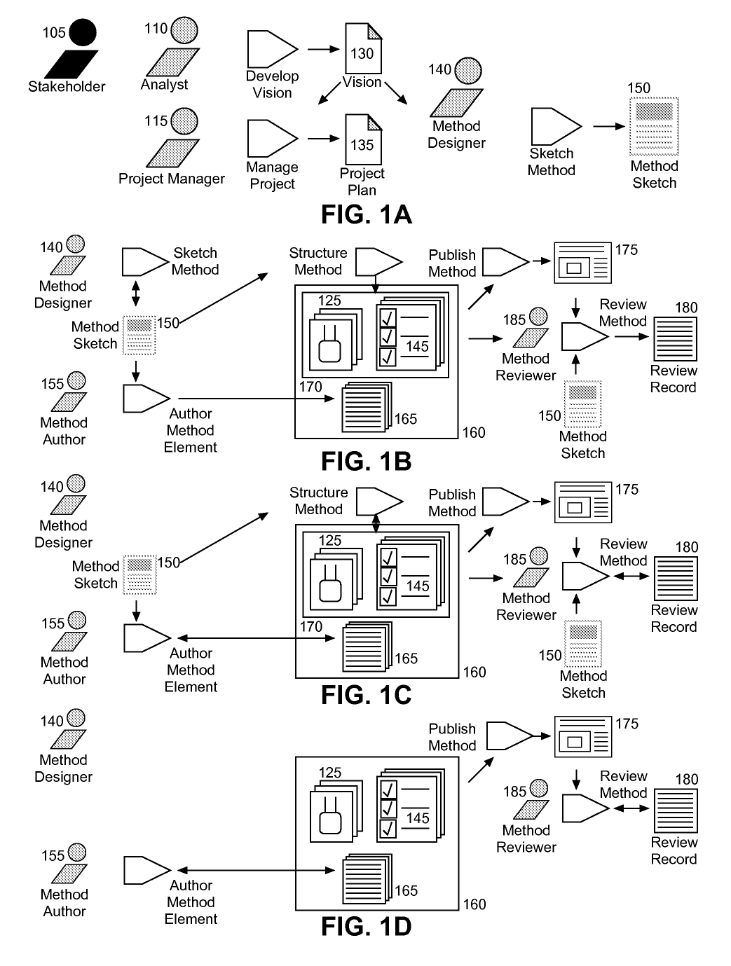

In further illustration, FIGS. 1A through 1D, taken together, are a pictorial illustration of a process for method authoring, in which FIG. 1A reflects an inception phase of the method authoring method, FIG. 1B reflects an elaboration phase of the method authoring method, FIG. 1C reflects a construction phase of the method authoring method, and FIG. 1D reflects a transition phase of the method authoring method. Taking first FIG. 1A, in an inception phase, an analyst 110 can query one or more stakeholders 105 to develop a vision 130 driving the development of a method. The vision 130 can include a statement of expectations by the stakeholders 105, the project scope, requirements and constraints. A project manager 115 in turn can generate a project plan 135 according to the vision 130. The project plan 135 can include an identification of phases of the project, along with phase durations and respective objectives. Yet further, initial project risks can be identified in the project plan 135. Thereafter, the project vision can be passed to a method designer to generate a method sketch 150. By way of example, the method sketch 150 can include an outline for the method such as a walkthrough of a lifecycle, a roadmap for the method, a brief description of candidate roles, tasks and work products and their relationships, a list of candidate method guidance, an early work breakdown structure, or a mockup of a Web site for the method.

Referring next to FIG. 1B, in the elaboration phase, a baseline method architecture is produced from the method sketch 150. Specifically, the method designer 140 can provided the method sketch 150 to a method author 155. The method author 155 in turn can produce a method definition 160 based upon the method sketch 150. The method definition can include the structural elements 170 of the method including method plug-ins 125 (both method packages and method elements) and method configurations 145. The method definition 160 further can include method element descriptions 165 for each of the method elements of the method plug-ins 125.

Based upon the method definition 160, a method Web site 175 can be published and a method reviewer 185 can review the Web site 175 to explore significant aspects of the method and to evaluate the usability of the Web site 175 and the results can be recorded in a review record 180. Thereafter, the vision 130 of FIG. 1A can be refined in order to establish a firmer understanding of the requirements driving the architectural and planning decisions reflected in the method sketch 150. Further, the project plan 135 of FIG. 1A can be updated and expanded.

Continuing with FIG. 1C, in the construction phase the method definition 160 can be completely defined to include all structure elements 170. Further, the method element descriptions 165 can be completed and reviewed. The Web site 175 for the method will have been generated completely and tested to identify defects such as broken links and poor usability. Finally, an iteration plan (not shown) can be completed and reviewed. Thereafter, in the transition phase of method authoring shown in FIG. 1D, the method as produced during the construction phase can be evaluated to ensure quality and consistency with the expectations set forth in the vision 130 and project plan 135 as described in connection with FIG. 1A and refined during the elaboration phase of FIG. 1B.

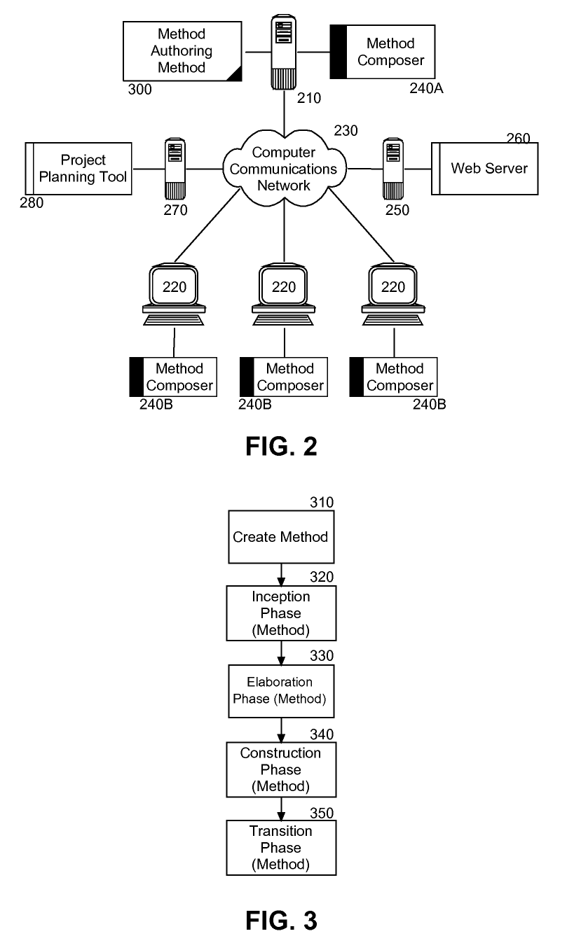

The process described in FIGS. 1A through 1D can be performed within a method authoring data processing system. In illustration, FIG. 2 is a schematic illustration of a method authoring data processing system. The system can include a host server 210 configured for communicative coupling to remote clients 220 over computer communications network. The host server 210 can support the operation of a method composer 240A, for example the Rational Method Composer™ manufactured by International Business Machines Corporation of Armonk, N.Y. Additionally, method composer clients 240B can be disposed respectively in different ones of the remote clients 220. It is to be recognized that the method composer 240A, 240B can reside wholly within each of the remote clients 220 or wholly within the host server 210, or both as the case may be.

Notably, method authoring method logic 300 can be coupled to the method composure 240A, 240B. The method authoring method 300 can include program code enabled to manage method authoring in the method composer 240A, 240B through an inception phase, an elaboration phase, a construction phase and a transition phase. In the inception phase, a method sketch for a method can be produced to guide the initial authorship of the method in the elaboration phase. As a result, a Web site for the method definition can be produced and published by Web server 260 in server platform 250. During the construction phase, the authored method can be reviewed and the method definition modified iteratively. Finally, the method can be deployed through the Web server 260 or in a project planning tool 280 in host 270 during the transition phase.

In yet further illustration, FIG. 3 is a flow chart illustrating a process for method authoring. Beginning in block 310, a method can be created and in block 320, an inception phase can be undertaken for the method. In this regard, during the inception phase, a method sketch 150 can be provided to reflect a vision and project plan provided by an analyst and project manager after interviewing relevant stakeholders. In block 330, an elaboration phase can consume the method sketch in order to set forth a method definition of method structure (including a selection of method plug-ins and method packages), and method descriptions.

The resultant method can be published as part of the elaboration phase into a Web site for review by a method reviewer. The review by the method reviewer can serve to refine the vision and project plan. In block 340 a construction phase can finalize the method definition according to the refined vision and project plan and the final method definition can be rendered in the Web site for review. Thereafter, in block 350 during a transition phase the method can be finalized for publication to the end user within a Web site as a final project deliverable.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method authoring method comprising:
generating a method sketch for a method from a vision for the method, the method sketch comprising a walkthrough of a lifecycle for the method;
constructing a method definition from the method sketch transforming the method definition into a Web site for the method and publishing the Web site for review by reviewers of the method; and,
iteratively refining the method definition based upon the review of the Web site.

2. The method of claim 1, wherein generating a method sketch for a method comprises:
identifying a method development strategy;
reviewing existing assets to identify reusable ones of the existing assets in defining the method;
further identifying candidate method elements deemed relevant to the method;
yet further identifying candidate relationships between the further identified candidate method elements; and,
describing selected ones of the candidate method elements.

3. The method of claim 1, wherein constructing a method definition from the method sketch, comprises:
defining a structure for method elements of the method in terms of key plug-ins and packages and corresponding dependencies;
further defining the method elements and relationships between the method elements;
yet further defining navigation views for a Web site reflecting the structure of the method elements, the defined method elements and the relationships; and,
even yet further defining method configurations by selecting a set of components and navigation views to be published in the Web site.

4. A computer program product comprising a computer usable medium embodying computer usable program code for method authoring the computer program product comprising:
computer usable program code for generating a method sketch for a method from a vision for the method, the method sketch comprising a walkthrough of a lifecycle for the method;
computer usable program code for constructing a method definition from the method sketch;
computer usable program code for transforming the method definition into a Web site for the method and publishing the Web site for review by reviewers of the method; and,
computer usable program code for iteratively refining the method definition based upon the review of the Web site.

5. The computer program product of claim 4, wherein the computer usable program code for generating a method sketch for a method comprises:
computer usable program code for identifying a method development strategy;
computer usable program code for reviewing existing assets to identify reusable ones of the existing assets in defining the method;
computer usable program code for further identifying candidate method elements deemed relevant to the method;
computer usable program code for yet further identifying candidate relationships between the further identified candidate method elements; and,
computer usable program code for describing selected ones of the candidate method elements.

6. The computer program product of claim 4, wherein the computer usable program code for constructing a method definition from the method sketch, comprises:
computer usable program code for defining a structure for method elements of the method in terms of key plug-ins and packages and corresponding dependencies;
computer usable program code for further defining the method elements and relationships between the method elements;
computer usable program code for yet further defining navigation views for a Web site reflecting the structure of the method elements, the defined method elements and the relationships; and,
computer usable program code for even yet further defining method configurations by selecting a set of components and navigation views to be published in the Web site.
